(19) United States
(12) Patent Application Publication
(10) Pub. No.: US 2024/0370160 A1
(43) Pub. Date: Nov. 7, 2024

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Kazuya AIDA, Kanagawa (JP)

(73) Assignee: FUJIFILM Business Innovation Corp., Tokyo (JP)

(21) Appl. No.: 18/502,497

(22) Filed: Nov. 6, 2023

(30) Foreign Application Priority Data
May 2, 2023 (JP) 2023-076159

(51) Int. Cl. G06F 3/0488; G06F 3/041; G06F 3/04842

(52) U.S. Cl. CPC G06F 3/0488; G06F 3/041; G06F 3/04842; G06F 2203/04108

(57) ABSTRACT

An information processing system includes: a processor configured to: in receiving a non-contact operation of one of multiple operators displayed on a display screen on which an operation surface is laminated, the multiple operators having respective operation detection areas each set for a corresponding one of the multiple operators that are displayed on the display screen and set for detecting an operation of the operator, the receiving being performed in response to detection of an instructing object approaching the display screen, the non-contact operation being performed in a state where the instructing object is not in contact with the operation surface, enlarge, on the display screen, one of the multiple operators displayed on the display screen, the operator being enlarged in response to a coordinate of the detected instructing object falling inside one of the operation detection areas for the operator a set number of times or more within a time period set in advance.

### CROSS-REFERENCE TO RELATED APPLICATIONS

This application is based on and claims priority under 35 USC 119 from Japanese Patent Application No. 2023-076159 filed May 2, 2023.

### BACKGROUND

### (i) Technical Field

The present disclosure relates to an information processing system, a non-transitory computer readable medium, and an information processing method.

### (ii) Related Art

Japanese Patent No. 5542224 discloses a coordinate detection method by which an operation not intended by a user is prevented in the following manner. In receiving an operation at a position away from a touch panel, an effective area for enabling two-dimensional coordinates for detecting a finger serving as an instructing object is decreased with the increase of a vertical distance between the finger and the touch panel.

Japanese Patent No. 5972692 discloses a user interface device that prevents a user's misoperation in the following manner. When a proximity operation for designating one of objects selectable with the proximity operation is detected, the proximity operation being performed by bringing a finger close to a display surface without a touch thereon, and when the size of the object is smaller than a threshold, the object is enlarged and displayed.

### SUMMARY

Aspects of non-limiting embodiments of the present disclosure relate to an information processing system, a non-transitory computer readable medium, and an information processing method that are enabled to enlarge and display, to a user unaccustomed to non-contact operation, at least one of operators having respective operation detection areas set for the operators, the operator being enlarged and displayed in receiving a non-contact operation of the operator having a corresponding one of the operation detection areas that includes an instructing object in response to the detection of the instructing object entering the operation detection area, the operator being not enlarged and displayed every time.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including: a processor configured to: in receiving a non-contact operation of one of multiple operators displayed on a display screen on which an operation surface is laminated, the multiple operators having respective operation detection areas each set for a corresponding one of the multiple operators that are displayed on the display screen and set for detecting an operation of the operator, the receiving being performed in response to detection of an instructing object approaching the display screen, the non-contact operation being performed in a state where the instructing object is not in contact with the operation surface, enlarge, on the display screen, one of the multiple operators displayed on the display screen, the operator being enlarged in response to a coordinate of the detected instructing object falling inside one of the operation detection areas for the operator a set number of times or more within a time period set in advance.

### BRIEF DESCRIPTION OF THE DRAWINGS

An exemplary embodiment of the present disclosure will be described in detail based on the following figures, wherein:

FIG. 1 is a view illustrating the system configuration of an image forming system of an exemplary embodiment of the present disclosure;

FIG. 2 is a view illustrating a state where a non-contact operation on a touch panel is received;

FIG. 3 is a view illustrating an example of an operation detection area set for each of operation buttons;

FIG. 4 is a view for explaining a state where an operation of a finger or the like staying in an operation detection area set for a corresponding one of the operation buttons for a predetermined time or longer is decided;

FIG. 5 is a block diagram illustrating the hardware configuration of an image forming apparatus in the exemplary embodiment of the present disclosure;

FIG. 6 is a block diagram illustrating the functional configuration of the image forming apparatus in the exemplary embodiment of the present disclosure;

FIG. 7 is a flowchart for explaining an operation for detecting a non-contact operation on the touch panel of the image forming apparatus in the exemplary embodiment of the present disclosure;

FIG. 8 is a view illustrating a state where a finger of a user makes a series of motions of exiting and entering the operation detection area a predetermined number of times;

FIG. 9 is a view illustrating a state where the operation button is enlarged on the touch panel;

FIG. 10 is a view illustrating a state where the enlarged operation button is decided;

FIG. 11 is a view illustrating a state where a predetermined area larger than the operation detection area around an operation button is set in Modification 1;

FIG. 12 is a flowchart for explaining an operation for detecting a non-contact operation on the touch panel of the image forming apparatus in Modification 1 of the exemplary embodiment of the present disclosure;

FIG. 13 is a view for explaining a state where the finger of the user makes the series of motions of exiting and entering the operation detection area for the operation button across the predetermined area the predetermined number of times;

FIG. 14 is a view for explaining a state where the finger of the user makes the series of motions of exiting and entering the operation detection area for the operation button within the predetermined area the predetermined number of times;

FIG. 15 is a flowchart for explaining the operation for detecting a non-contact operation on the touch panel of the image forming apparatus in Modification 2 of the exemplary embodiment of the present disclosure;

FIG. 16 is a view for explaining a specific operation example of a case where a predetermined count for enlarging an operation button is increased from one time to two times in Modification 2 of the exemplary embodiment of the present disclosure;

FIG. 17 is a view for explaining a specific different operation example of the case where the predetermined count for enlarging an operation button is increased from one time to two times in Modification 2 of the exemplary embodiment of the present disclosure;

FIG. 18 is a flowchart for explaining an operation for detecting a non-contact operation on the touch panel of the image forming apparatus in Modification 3 of the exemplary embodiment of the present disclosure;

FIG. 19 is a view for explaining a state where an operation button is not enlarged in Modification 3 of the exemplary embodiment of the present disclosure because of a large size of the operation button even though the finger makes the series of motions of exiting and entering the operation detection area multiple times;

FIG. 20 is a flowchart for explaining an operation for detecting a non-contact operation on the touch panel of the image forming apparatus in Modification 4 of this exemplary embodiment;

FIG. 21 is a view illustrating a state where the finger makes the series of motions of exiting and entering the operation detection areas for the respective operation buttons the predetermined number of times or more in a case where a large number of operation buttons are disposed on the display screen of the touch panel;

FIG. 22 is a view illustrating a state where two operation buttons that are an operation button displaying “G” and an operation button displaying “H” are simultaneously enlarged;

FIG. 23 is a flowchart for explaining an operation for detecting a non-contact operation on the touch panel of the image forming apparatus in Modification 5 of this exemplary embodiment;

FIG. 24A is a view for explaining a state where a predetermined area is set around each of the operation buttons;

FIG. 24B is a view illustrating operation buttons (R. T. Y. F. H. V. B, and N) in the predetermined areas overlapping with the operation button (G);

FIG. 25 is a view illustrating a case where the finger of the user makes the series of motions of exiting and entering the operation detection area for the operation button displaying “G” the predetermined number of times; and

FIG. 26 is a view illustrating a state where not only the operation button displaying “G” but also the eight operation buttons displaying “R”. “T”. “Y”, “F”, “H”, “V”, “B”, and “N” disposed close to the operation button displaying “G” are enlarged.

### DETAILED DESCRIPTION

An exemplary embodiment of the present disclosure will then be described in detail with reference to the drawings.

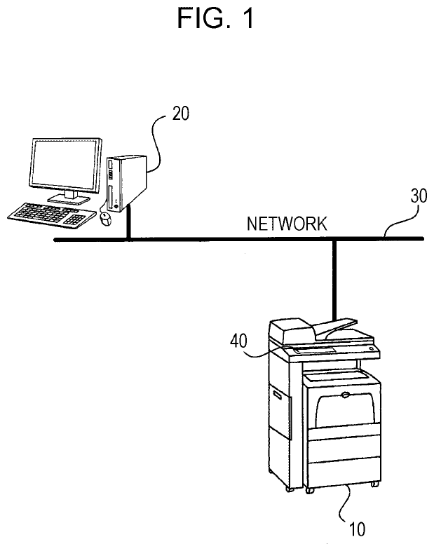

FIG. 1 is a view illustrating the system configuration of an image forming system of an exemplary embodiment of the present disclosure.

As illustrated in FIG. 1, the image forming system of the exemplary embodiment of the present disclosure is an information processing system including an image forming apparatus 10 and a terminal apparatus 20 that are connected to each other via a network 30. The terminal apparatus 20 generates print data and transmits the generated print data to the image forming apparatus 10 via the network 30. The image forming apparatus 10 receives the print data transmitted from the terminal apparatus 20 and outputs an image corresponding to the print data onto a sheet. The image forming apparatus 10 is an information processing apparatus what is called a multi-function printer having multiple functions such as a printing function, a scanning function, a copying function, and a faxing function.

The image forming apparatus 10 is provided with a touch panel 40 on the top surface of the front part of the image forming apparatus 10. The touch panel 40 displays various pieces of information to a user and receives an operation from the user.

The touch panel 40 has a display screen on which an operation surface is laminated. Operators such as operation buttons for receiving an operation from the user are displayed on the display screen. The touch panel 40 has operation detection areas for detecting an operation of an operation button displayed on the display screen, the operation detection areas being set for the respective operation buttons. Typical touch panels detect an instructing object such as a finger brought into contact with the operation detection area and thereby detect the operation button operated by a user.

The image forming apparatus 10 of this exemplary embodiment is capable of receiving a non-contact operation in addition to the contact operation of the touch panel 40 as described. The non-contact operation is performed on the operation button displayed on the display screen in a state the instructing object is not in contact with the operation surface. The non-contact operation is received in response to the detection of an instructing object such as a finger close to the display screen of the touch panel 40.

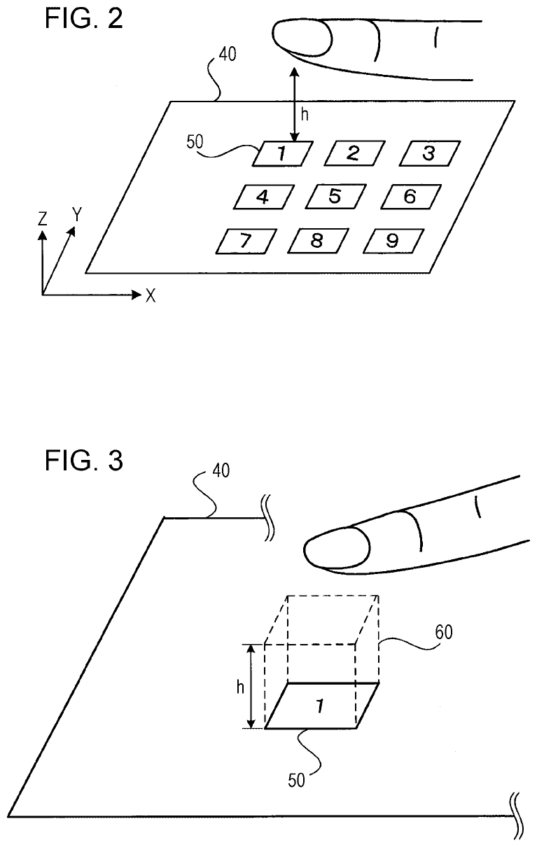

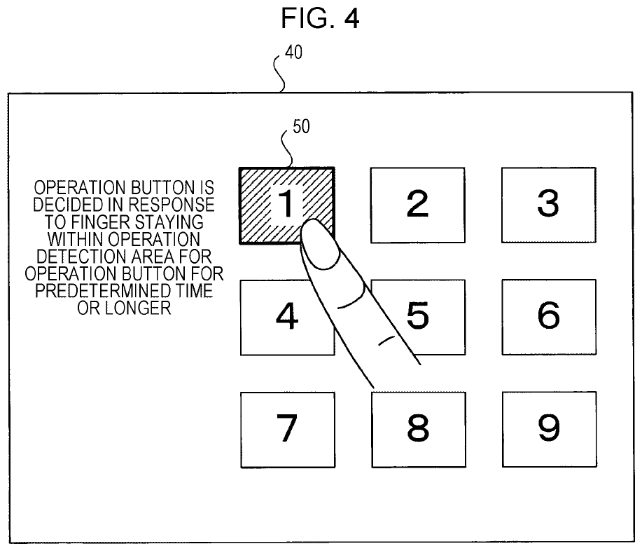

FIG. 2 illustrates a state where a non-contact operation is received on the touch panel 40 as described above. With reference to FIG. 2, a state where a finger of a user present at a distance h in a height direction from one of operation buttons 50 displayed on the surface of the touch panel 40 is detected is illustrated. FIG. 3 illustrates an example of an operation detection area 60 set for each operation button 50. As illustrated in FIG. 3, an area where the instructing object such as a finger is detectable is set as the operation detection area 60 above the operation button 50. Detecting the finger or the like entering the operation detection area 60 means an operation performed of the operation button 50.

If the finger or the like stays in the operation detection area 60 set for one of the operation buttons 50 for a predetermined time or longer, the operation of the operation button 50 is decided. For example, as illustrated in FIG. 4, when the finger stays in the operation detection area 60 for one of the operation buttons 50 that displays “1”, for example, two seconds or longer, the selection of the operation button 50 is decided.

In such a configuration in which a non-contact operation is received, in response to an instructing object such as a finger entering one of operation detection areas each set for a corresponding one of the operation buttons, the operation button is enlarged to prevent a misoperation in some cases. However, a user accustomed to non-contact operation feels strenuous if the operation button is enlarged every time in response to the finger simply entering the operation detection area.

Hence, the image forming apparatus 10 of this exemplary embodiment is configured to enlarge, only for a user unaccustomed to non-contact operation on the basis of control as to be described later, at least one of operation buttons having respective operation detection areas set for the operation buttons. The operation button is enlarged in receiving a non-contact operation of the operation button having a corresponding one of the operation detection areas that includes an instructing object such as a finger in response to the detection of the instructing object entering the operation detection area, the operation button being not enlarged every time.

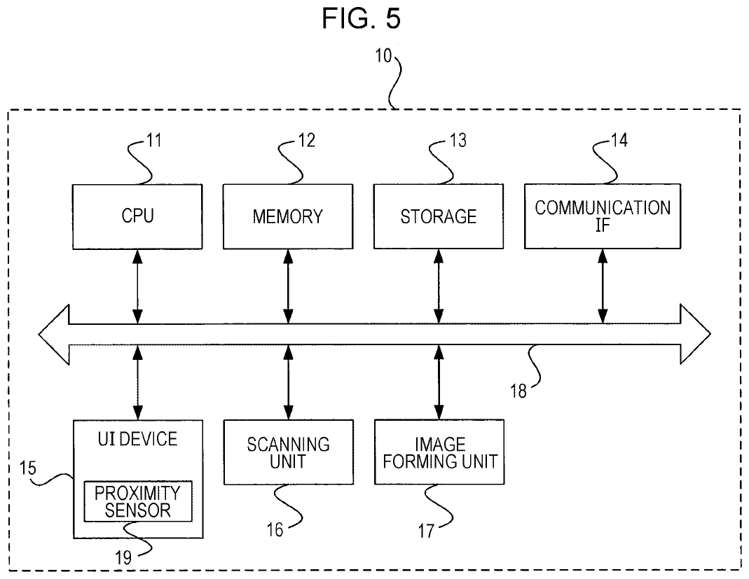

Subsequently, FIG. 5 illustrates the hardware configuration of the image forming apparatus 10 in the image forming system of this exemplary embodiment.

As illustrated in FIG. 5, the image forming apparatus 10 includes a CPU 11, a memory 12, a storage 13 such as a hard disk drive, a communication interface (abbreviated as IF) 14 that transmits and receives data to and from an external apparatus or the like via the network 30, a user interface (abbreviated as UI) device 15 composed of a touch panel and the like having a proximity sensor 19, a scanning unit 16, and an image forming unit 17. These components are connected to each other via a control bus 18.

The image forming unit 17 prints an image on the recording medium such as a printing sheet after processes such as charging, light exposure, development, transfer, and fixing.

The proximity sensor 19 detects the coordinates of the instructing object such as the finger approaching the operation surface by, for example, an electrostatic capacitance method. However, the detection method for the proximity sensor 19 is not limited to the electrostatic capacitance method and may use a method by which measurement light such as infrared rays or laser light is radiated onto the instructing object and thereby reflected light is detected, a method by which the approaching of the instructing object to the operation button is detected from an image captured with a camera or the like, or the like.

The instructing object for operating the touch panel 40 is not limited to a hand or a finger of the user and may be any object such as a stylus pen as long as the touch panel 40 is operable with the object. However, a case where the instructing object is a finger of the user will be described below.

The CPU 11 is a processor configured to execute predetermined processes in accordance with a control program stored in the memory 12 or the storage 13 and thus controls the operation of the image forming apparatus 10. In the description of this exemplary embodiment, the control program stored in the memory 12 or the storage 13 is read out and run by the CPU 11; however, how to provide the control program is not limited to this. The control program may be provided in such a manner as to be recorded in a computer readable recording medium. For example, the program may be provided in such a manner as to be recorded in an optical disk such as a compact disc (CD)-ROM or a digital versatile disc (DVD)-ROM or recorded in a semiconductor memory such as a universal serial bus (USB) memory or a memory card. Control program may also be obtained from an external apparatus via a communication network connected to the communication interface 14.

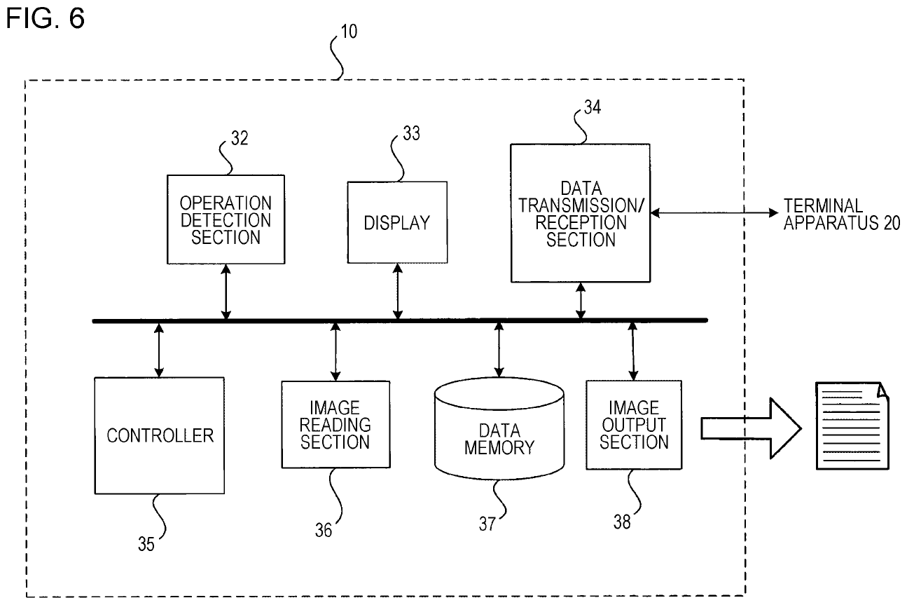

FIG. 6 is a block diagram illustrating the functional configuration of the image forming apparatus 10 implemented by running the control program described above.

As illustrated in FIG. 6, the image forming apparatus 10 of this exemplary embodiment includes an operation detection section 32, a display 33, a data transmission/reception section 34, a controller 35, an image reading section 36, a data memory 37, and an image output section 38.

The data transmission/reception section 34 transmits and receives data to and from an external apparatus such as the terminal apparatus 20. The controller 35 performs control to generate print data on the basis of a print job received from the terminal apparatus 20 via the data transmission/reception section 34 and to output the generated print data from the image output section 38. The data memory 37 stores various pieces of data such as the print data generated by the controller 35.

The image output section 38 outputs an image on the recording medium such as a printing sheet under the control of the controller 35. The image reading section 36 reads a document image from a set document under the control of the controller 35.

The display 33 is controlled by the controller 35 and displays various pieces of information to the user. The operation detection section 32 detects various operations performed by the user on the display 33. The display 33 and the operation detection section 32 form the touch panel 40.

The controller 35 enlarges one of the multiple operation buttons on the display screen displayed on the display 33 in response to the operation detection section 32 detecting the coordinates of the instructing object such as a detected finger falling inside the operation detection area for the operation button displayed on the display screen a set number of times or more within a time period set in advance. The operation detection section 32 detects the coordinates in receiving a non-contact operation performed on an operation button displayed on the display screen of touch panel 40.

It is considered that a user unaccustomed to non-contact operation performs such an operation that moves the finger in and out of the operation detection area multiple times. Accordingly, in this exemplary embodiment, if the coordinates of the finger fall inside and outside the operation detection area set for the operation button multiple times, the controller 35 determines that the user is a user unaccustomed to non-contact operation and enlarges the operation button on the operation screen.

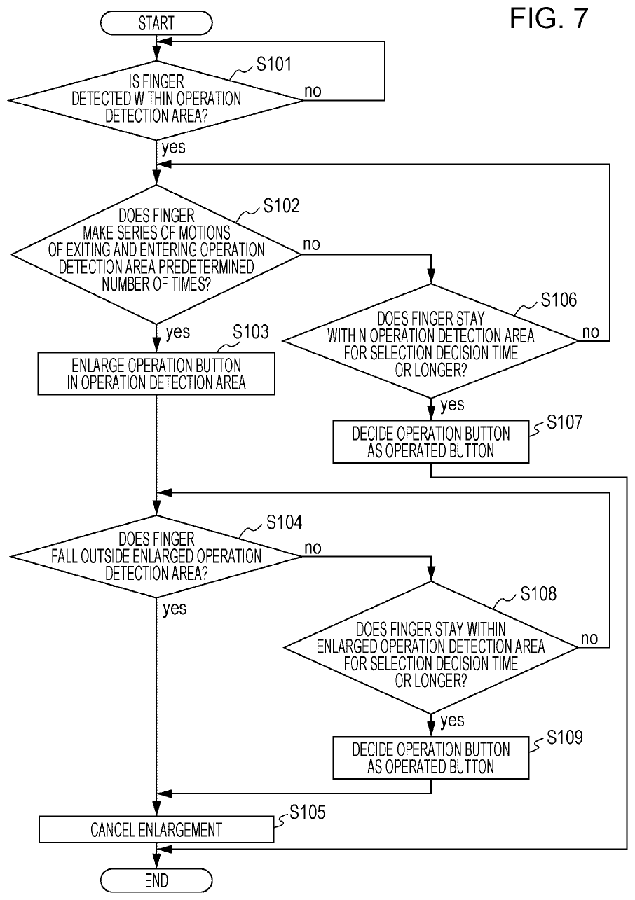

Subsequently, the operation for detecting a non-contact operation on the touch panel 40 of the image forming apparatus 10 in this exemplary embodiment will be described with reference to a flowchart in FIG. 7.

First, in step S101, the controller 35 determines whether the operation detection section 32 detects the finger of the user in the operation detection area 60.

If it is determined in step S101 that the operation detection section 32 detects the finger in the operation detection area 60, the controller 35 determines in step S102 whether the finger has made a series of motions of exiting and entering the operation detection area 60 a predetermined number of times.

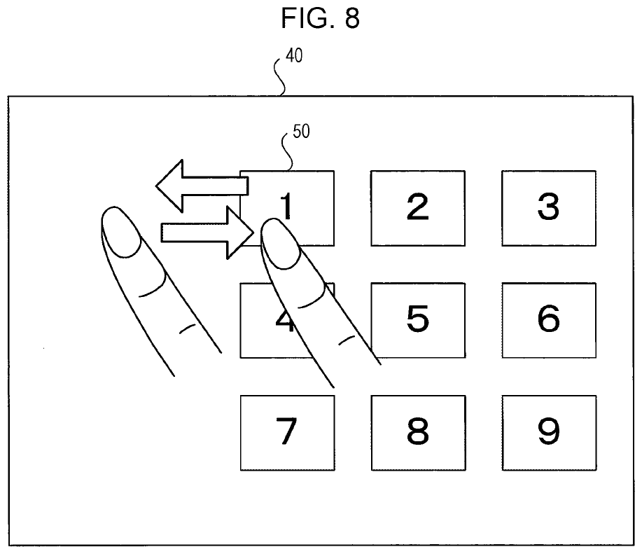

FIG. 8 illustrates a state where the finger of the user makes the series of motions of exiting and entering the operation detection area 60 the predetermined number of times. In FIG. 8, a state where the finger of the user enters the operation detection area 60 set for the operation button 50 once, then exits the operation detection area 60, and enters the operation detection area 60 again.

It is determined in step S102 that the finger makes the series of motions of exiting and entering the operation detection area 60 the predetermined number of times, the controller 35, in step S103, enlarges the operation button 50 corresponding to the operation detection area 60 which the finger makes the series of motions of exiting and entering the predetermined number of times on the touch panel 40.

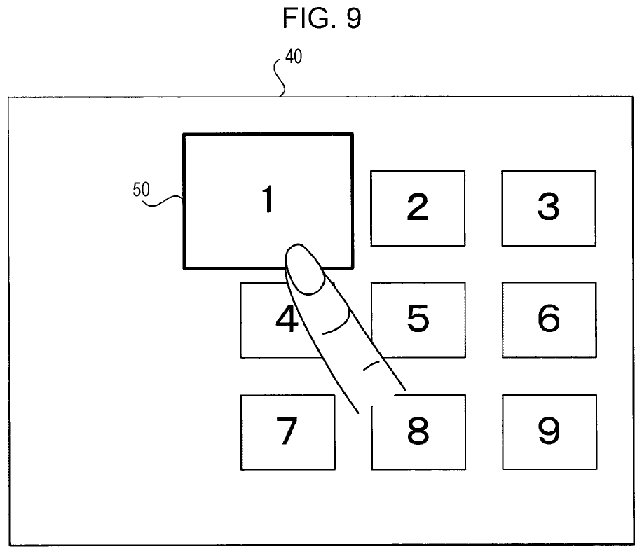

FIG. 9 illustrates a state where the operation button 50 is enlarged on the touch panel 40 in this manner. FIG. 9 illustrates a state where the operation button 50 denoted by the character “1” is enlarged.

After the operation button 50 is enlarged, the controller 35 determines in step S104 whether the finger falls outside the operation detection area 60 for the enlarged operation button 50.

If it is determined in step S104 that the finger falls outside the operation detection area 60 for the enlarged operation button 50, the controller 35, in step S105 cancels the enlargement of the operation button 50 and restores the size of the operation button 50 to a usual size.

If it is determined in step S104 that the finger does not fall outside the operation detection area 60 for the enlarged operation button 50, the controller 35 determines in step S108 whether the finger has stayed within the operation detection area 60 for the enlarged operation button 50 for a selection decision time or longer, for example, two seconds or longer.

If it is determined in step S108 that the finger has stayed within the operation detection area 60 for the enlarged operation button 50 for the selection decision time or longer, the controller 35 executes a process for deciding the operation button 50 in step S109.

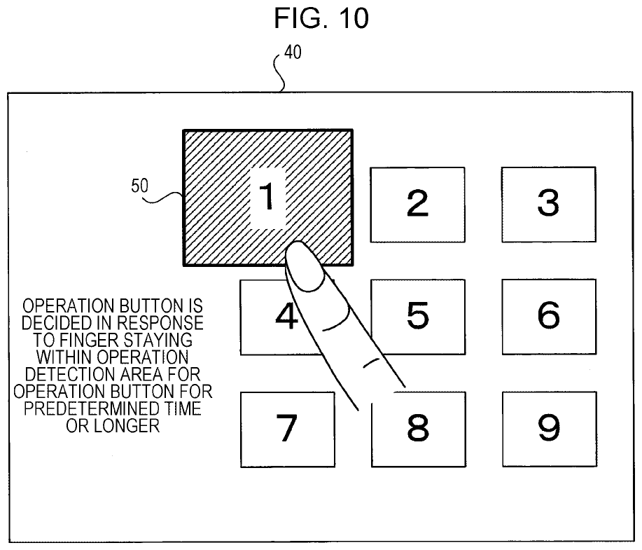

FIG. 10 illustrates a state where the enlarged operation button 50 is decided in this manner. FIG. 10 illustrates the state where the operation button 50 denoted by the character “1” is decided in an enlarged state.

If it is determined in step S108 that the finger has not stayed within the operation detection area 60 for the enlarged operation button 50 for the selection decision time or longer, the controller 35 returns to step S104.

Further, if it is determined in step S102 that the finger of the user has not made the series of motions of exiting and entering the operation detection area 60 the predetermined number of times, the controller 35 determines in step S106 whether the finger has stayed within the operation detection area 60 for the operation button 50 for the selection decision time or longer, for example, two seconds or longer.

If it is determined in step S106 that the finger has stayed within the operation detection area 60 for the operation button 50 for the selection decision time or longer, the controller 35 executes the process for deciding the operation button 50 in step S107.

If it is determined in step S106 that the finger has not stayed within the operation detection area 60 for the operation button 50 for the selection decision time or longer, the controller 35 returns to step S102.

By performing the process as described above, the control to decide the operation button 50 is performed without enlarging the operation button 50 for the user accustomed to non-contact operation. For the user unaccustomed to non-contact operation, control to decide the operation button 50 after the operation button 50 is enlarged.

### Modification 1

In the exemplary embodiment described above, if the finger of the user has made the series of motions of exiting and entering the operation detection area 60 for the operation button 50 the predetermined number of times, the operation button 50 is enlarged. However, there is a possibility that even though the user does not intend to enlarge the operation button 50, the operation button 50 is enlarged simply in response to the finger making the series of motions of exiting and entering the operation detection area 60 for the operation button 50 the predetermined number of times. For example, even in response to a normal movement of the finger, for example, the user moving the finger between the operation detection areas 60 for the operation buttons 50 while wavering in operating an operation button 50, an unintended operation button 50 is enlarged on occasions.

Hence, in Modification 1 of this exemplary embodiment, the controller 35 sets a predetermined area larger than the operation detection area 60 around the operation button 50. If the coordinates of the detected finger fall inside the operation detection area 60 set for one of the operation buttons 50 within the predetermined area a set number of times or more within the time period set in advance, the operation button 50 is enlarged on the display screen of the touch panel 40.

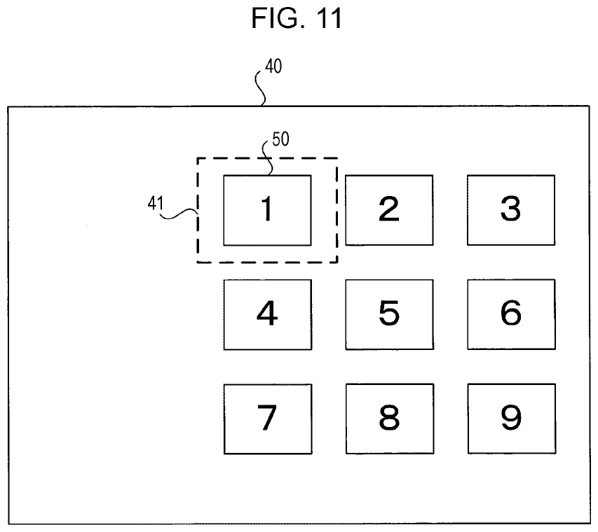

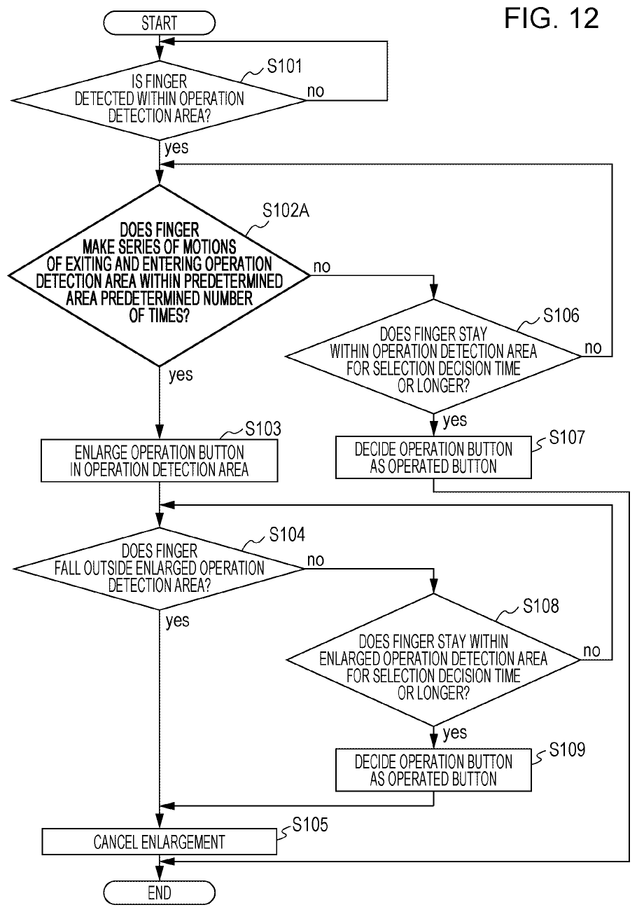

For example, as illustrated in FIG. 11, the controller 35 sets a predetermined area 41 larger than the operation detection area 60 around the operation button 50.

An operation for detecting a non-contact operation on the touch panel 40 of the image forming apparatus 10 in Modification 1 of this exemplary embodiment will then be described with reference to a flowchart in FIG. 12.

The flowchart in FIG. 12 has the same steps as those in the flowchart illustrated in FIG. 7 except that step S102 is replaced with step S102A. The description of steps other than step S102A in the flowchart in FIG. 12 is thus omitted.

In Modification 1, if it is determined in step S101 that the operation detection section 32 detects the finger in the operation detection area 60, the controller 35 determines in step S102A whether the finger makes the series of motions of exiting and entering the operation detection area 60 within the predetermined area 41 the predetermined number of times.

If it is determined in step S102A that the finger makes the series of motions of exiting and entering the operation detection area 60 within the predetermined area 41 the predetermined number of times, the controller 35, in step S103, enlarges, on the touch panel 40, the operation button 50 corresponding to the operation detection area 60 which the finger makes the series of motions of exiting and entering the predetermined number of times.

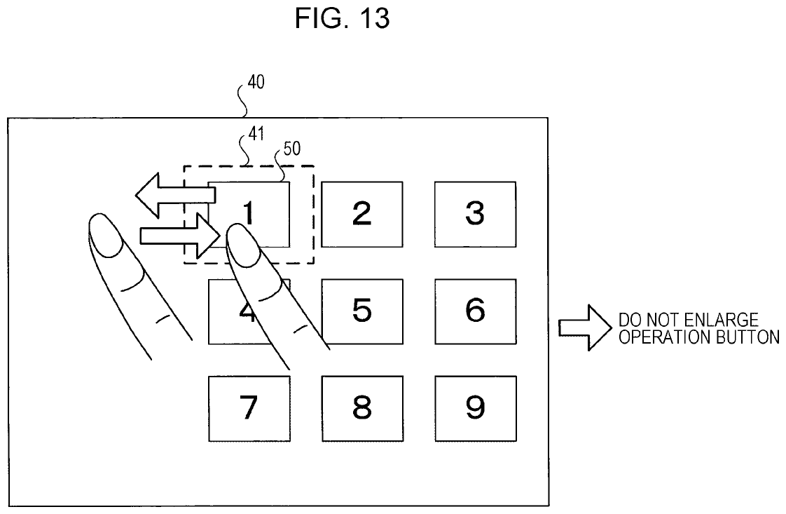

That is, in Modification 1, as illustrated in FIG. 13, if the finger of the user has made the series of motions of exiting and entering the operation detection area 60 for the operation button 50 across the predetermined area 41 the predetermined number of times, the operation button 50 is not enlarged.

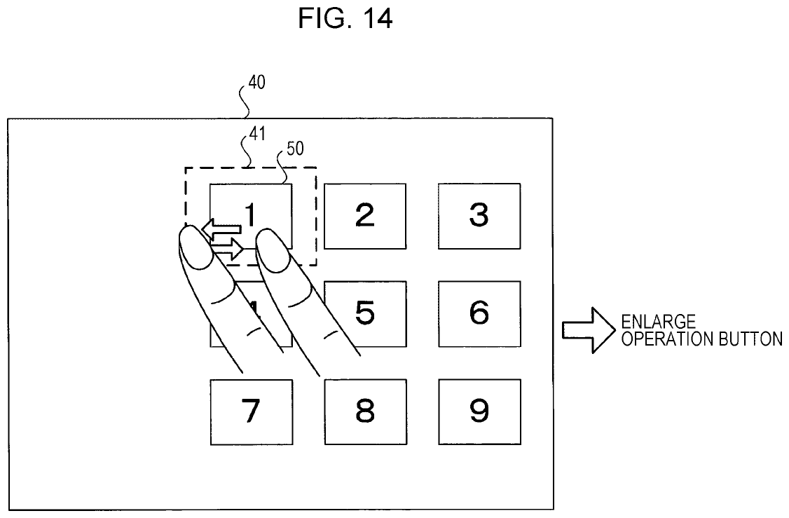

In Modification 1, as illustrated in FIG. 14, if the finger of the user has made the series of motions of exiting and entering the operation detection area 60 for the operation button 50 within the predetermined area 41 the predetermined number of times, the operation button 50 is enlarged.

The predetermined area 41 is provided to perform the determination as described above for the following reason. Suppose a case where a user intends to operate one of the operation buttons 50 and to stay a finger within the operation detection area 60 for the operation button 50 but moves the finger unintentionally because they are unaccustomed to non-contact operation. It is considered that the finger does not largely fall outside the operation detection area 60 in this case. In contrast, if the finger of the user largely falls outside the operation detection area 60 for the operation button 50 in the movement, but, for example, if the finger enters the operation detection area 60 for the operation button 50 again, the user is considered to have no intention of operating the operation button 50.

### Modification 2

Modification 2 of this exemplary embodiment in which the operation button 50 is made less likely to be enlarged in response to a normal movement of the finger of the user will then be described.

In Modification 2 of this exemplary embodiment, if the user performs the operation determined as not requiring the operation button 50 to be enlarged, the controller 35 increases a count for enlarging an operation button 50.

Specifically, if an operation for deciding the selection (selection decision operation) of one of the operation buttons 50 is performed without enlarging the operation button 50, the controller 35 determines that the user is a user who is accustomed to contact operation and does not require the operation button 50 to be enlarged and increases the count for enlarging an operation button 50.

If an operation for deciding the selection decision operation of one of the operation buttons 50 is not performed after the operation button 50 is enlarged, the controller 35 determines that the user does not require the operation button 50 to be enlarged and increases the count for enlarging an operation button 50.

The following case will be described below as an example of increasing the count for enlarging an operation button 50. The operation button 50 is enlarged in response to the series of motions of exiting and entering the operation detection area 60 two times changed from one time.

If the selection decision operation is performed of one of the operation buttons 50 after the operation button 50 is enlarged, the controller 35 changes the count for enlarging an operation button 50 to an original initial value.

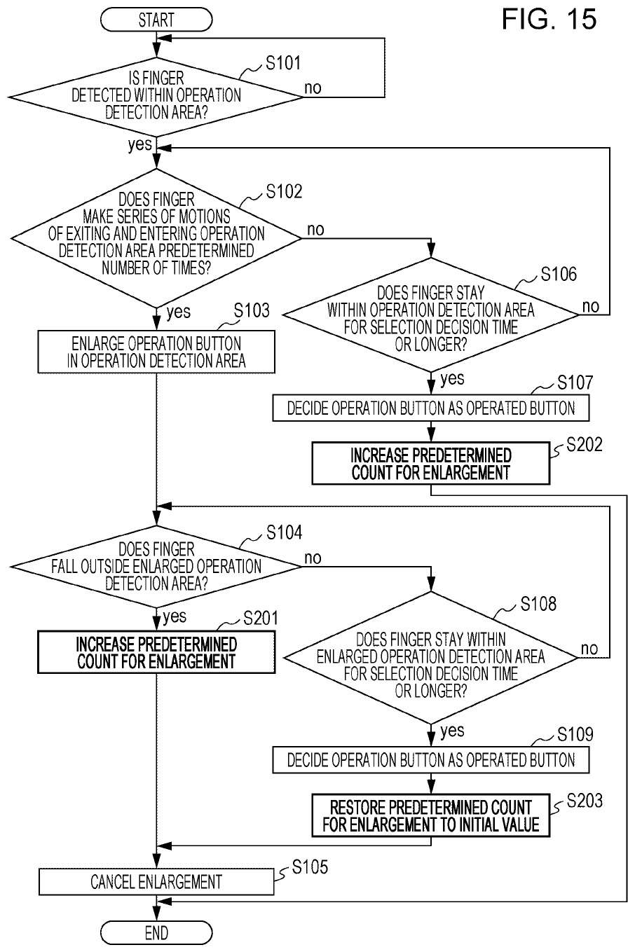

The operation for detecting a non-contact operation on the touch panel 40 of the image forming apparatus 10 in Modification 2 of this exemplary embodiment will then be described with reference to a flowchart in FIG. 15.

The flowchart in FIG. 15 has the same steps as those in the flowchart illustrated in FIG. 7 except that steps S201 to S203 are added thereto. The description of steps other than steps S201 to S203 in the flowchart in FIG. 15 is thus omitted.

In Modification 2, if it is determined in step S104 that the finger falls outside the operation detection area 60 for the enlarged operation button 50, the controller 35 increases the predetermined count for enlarging an operation button 50 in step S201 and then cancels the enlargement of the operation button 50 to restore the size of the operation button 50 to the usual size in step S105.

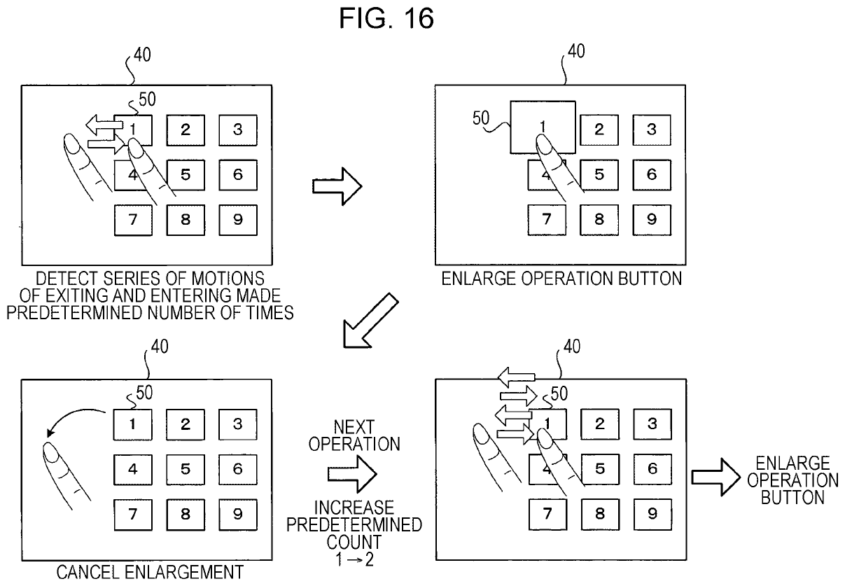

For example, as illustrated in FIG. 16, if the operation button 50 is enlarged in response to the finger making the series of motions of exiting and entering the operation detection area 60 for the operation button 50 one time but is then canceled in response to the finger deviating from the operation detection area 60 for the operation button 50, the predetermined count is increased from one time to two times. As the result, on and after this, the operation button 50 is enlarged only in response to the finger making the series of motions of exiting and entering the operation detection area 60 for the operation button 50 two times or more. The operation button 50 is thus made less likely to be enlarged than in the case where the predetermined count is not increased.

In Modification 2, the controller 35 executes the process for deciding the operation button 50 not enlarged in step S107 and thereafter increases the predetermined count for enlarging an operation button 50 in step S202.

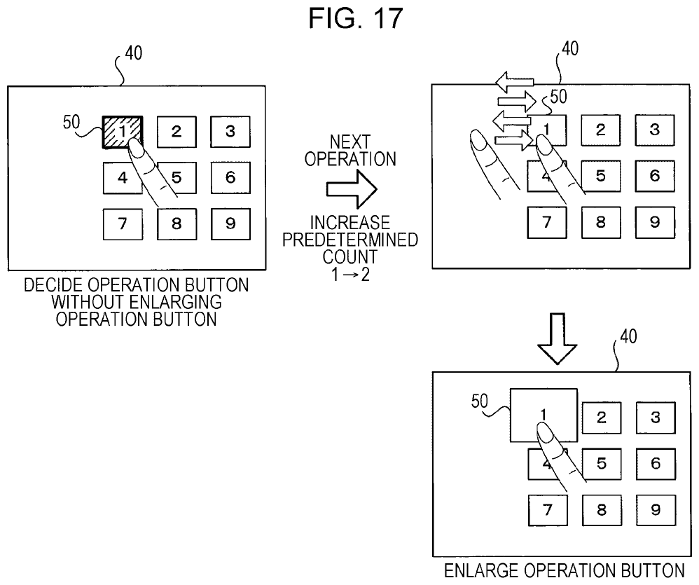

For example, if the process for deciding the operation button 50 is executed without enlarging the operation button 50 as illustrated in FIG. 17, the predetermined count is increased from one time to two times. As the result, on and after this, the operation button 50 is enlarged only in response to the finger making the series of motions of exiting and entering the operation detection area 60 for the operation button 50 two times or more. The operation button 50 is thus made less likely to be enlarged than in the case the predetermined count is not increased.

Further, in Modification 2, the controller 35 executes the process for deciding the enlarged operation button 50 in step S109 and thereafter restores the predetermined count for enlarging an operation button 50 to the initial value in step S203.

It is also considered that if the operation button 50 is made less likely to be enlarged in a case of a narrow and small area of the operation button 50 or a short distance between the adjacent operation buttons 50, user-friendly operation is deteriorated.

The controller 35 may thus be configured as below. Suppose a case where the selection decision operation of one of is not performed after the operation button 50 is enlarged. If the area of the operation button 50 takes on a value lower than or equal to a value set in advance, or if a distance between one of the operation buttons 50 and a different one of the operation buttons 50 that is adjacent to the operation button 50 takes on a value lower than or equal to a value set in advance, the controller 35 does not increase the count for enlarging an operation button 50.

### Modification 3

Modification 3 of this exemplary embodiment in which the operation button 50 is enlarged in response to the normal movement of the finger of the user will then be described.

In the exemplary embodiment described above, if the finger of the user has made the series of motions of exiting and entering the operation detection area 60 for the operation button 50 the predetermined number of times, the operation button 50 is enlarged. However, it is considered that, for example, if only several large operation buttons 50 are disposed on the display screen of the touch panel 40, the operation buttons 50 are not required to be enlarged in a larger size.

Hence, in Modification 3 of this exemplary embodiment, if the area of the operation button 50 displayed on the touch panel 40 takes on a value higher than or equal to a value set in advance, the screen is determined as not requiring the enlargement. No matter how many times the finger makes the series of motions of exiting and entering the operation detection area 60, the operation button 50 is not enlarged.

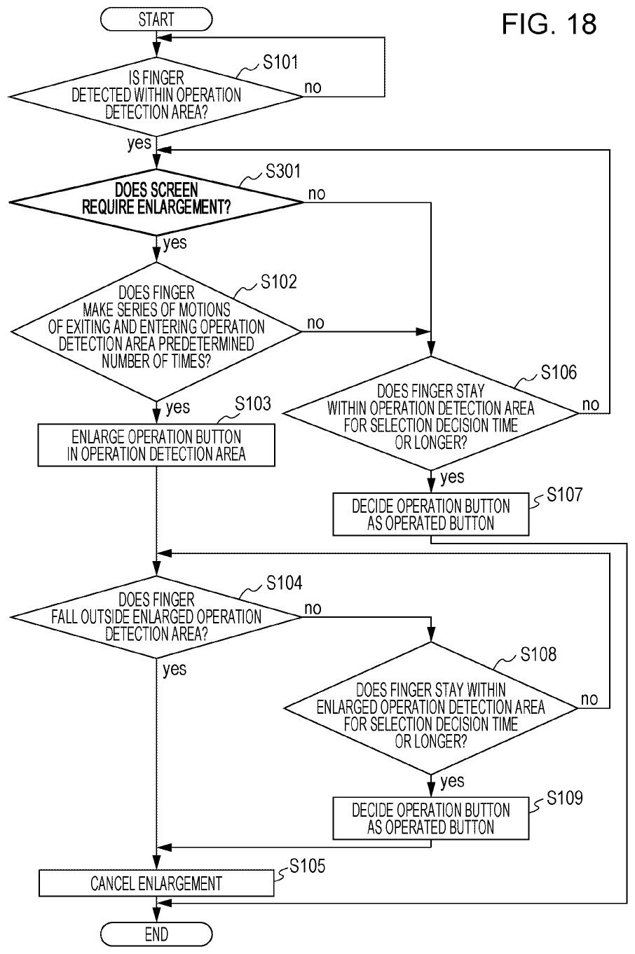

An operation for detecting a non-contact operation on the touch panel 40 of the image forming apparatus 10 in Modification 3 of this exemplary embodiment will then be described with reference to a flowchart in FIG. 18.

The flowchart in FIG. 18 has the same steps as those in the flowchart illustrated in FIG. 7 except that step S301 is added between step S101 and step S102. The description of steps other than step S301 in the flowchart in FIG. 18 is thus omitted.

In Modification 3, if it is determined in step S101 that the operation detection section 32 detects the finger in the operation detection area 60, the controller 35 determines in step S301 whether the display screen is a screen requiring the operation button 50 to be enlarged. For example, if the sizes of all of the operation buttons 50 on the display screen take on a value higher than or equal to a certain value, the controller 35 determines that the screen is a screen not requiring the enlargement.

If it is determined in step S301 that the display screen is not a screen requiring the operation button 50 to be enlarged, the controller 35 does not proceed to the determination step in step S102 but proceeds to the determination step in step S106.

If it is determined in step S301 that the display screen is a screen requiring the operation button 50 to be enlarged, the controller 35 proceeds to the determination step in step S102.

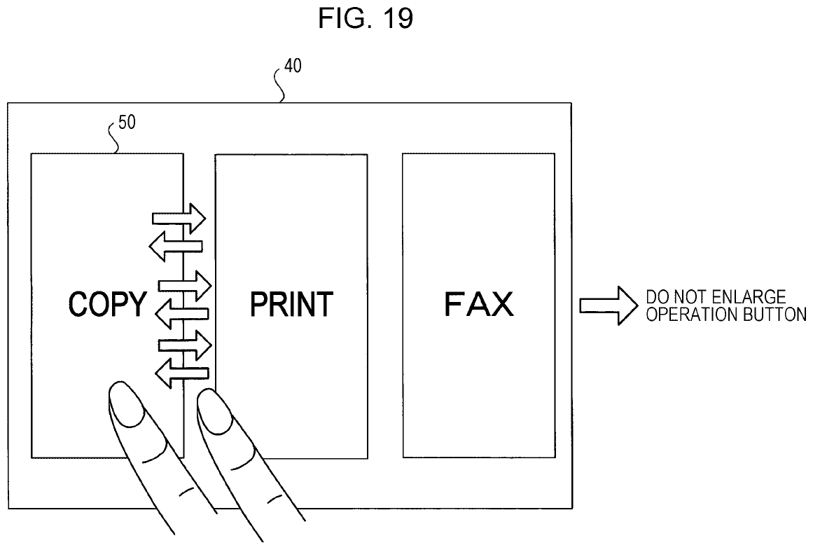

If the finger makes the series of motions of exiting and entering the operation detection area 60 for the operation button 50 displayed on the display screen of the touch panel 40 multiple times, but if the operation buttons 50 are large, the control as described above causes the operation button 50 not to be enlarged as illustrated in FIG. 19.

### Modification 4

In the exemplary embodiment described above, if the finger of the user has made the series of motions of exiting and entering the operation detection area 60 for the operation button 50 the predetermined number of times, the operation button 50 is enlarged. However, suppose a case where each operation button 50 is considerably small in size and thus a distance between the operation button 50 and a different one of operation buttons 50 that is adjacent to the operation button 50 is short, that is, a case where the multiple operation buttons 50 are arranged densely. In this case, it is considered that even if one operation button 50 is enlarged, the operation button 50 is not intended by the user.

Hence, in Modification 4 of this exemplary embodiment, if the coordinates of the detected finger fall inside the operation detection areas 60 for the respective operation buttons 50 a set number of times or more within a time period set in advance, the controller 35 enlarges the operation buttons 50 on the display screen of the touch panel 40.

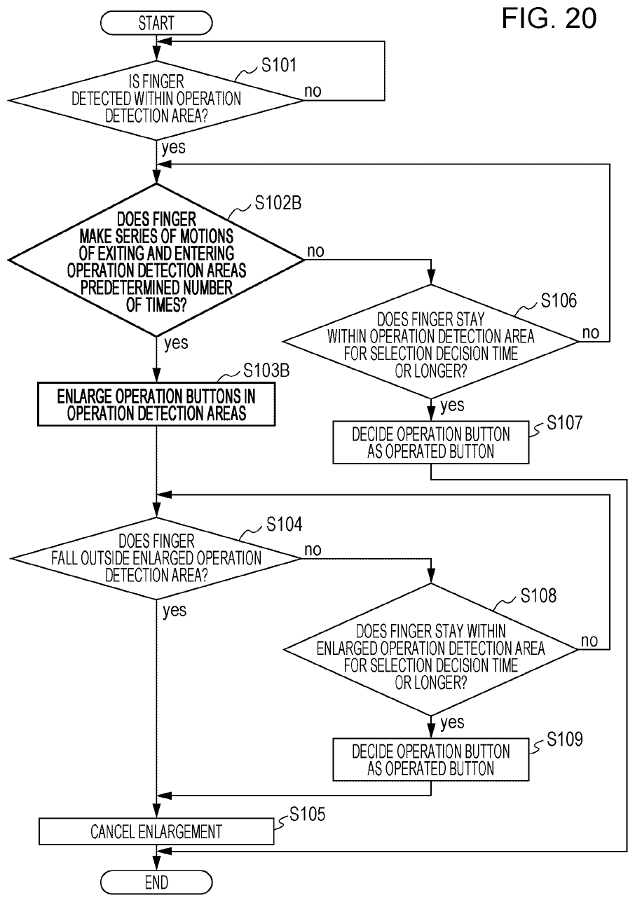

An operation for detecting a non-contact operation on the touch panel 40 of the image forming apparatus 10 in Modification 4 of this exemplary embodiment will then be described with reference to a flowchart in FIG. 20.

The flowchart in FIG. 20 has the same steps as those in the flowchart illustrated in FIG. 7 except that steps S102 and S103 are respectively replaced with steps S102B and S103B. The description of steps other than steps S102B and S103B in the flowchart in FIG. 20 is thus omitted.

In Modification 4, if it is determined in step S101 that the operation detection section 32 detects the finger in the operation detection area 60, the controller 35 determines in step S102B whether the finger makes the series of motions of exiting and entering the operation detection areas 60 the predetermined number of times.

If it is determined in step S102B that the finger makes the series of motions of exiting and entering the operation detection areas 60 the predetermined number of times, the controller 35, in step S103B, enlarges, on the touch panel 40, the operation buttons 50 corresponding to the operation detection areas 60 which the finger makes the series of motions of exiting and entering the predetermined number of times.

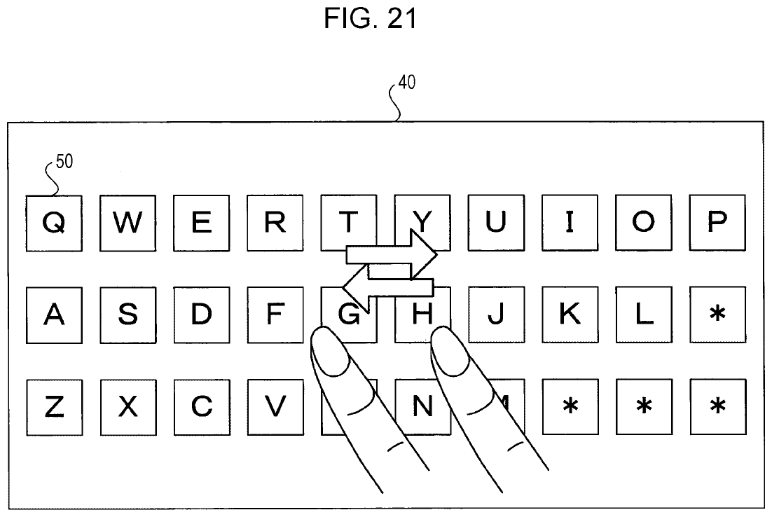

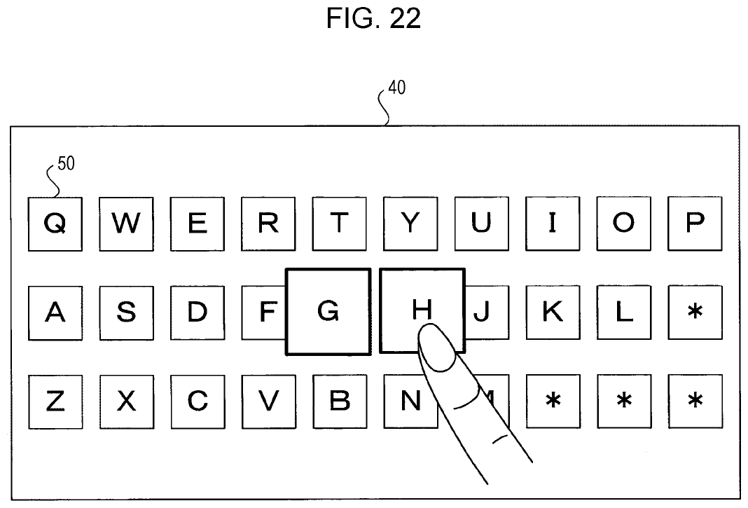

For example, as illustrated in FIG. 21, a case where a large number of operation buttons 50 are arranged on the display screen of the touch panel 40 will be described. In the state as described above, the user, with the finger, makes the series of motions of exiting and entering both of the operation detection area 60 for the operation button 50 displaying “G” and the operation detection area 60 for the operation button 50 displaying “H” the predetermined number of times or more. In response to this, as illustrated in FIG. 22, the two operation buttons 50 that are the operation button 50 displaying “G” and the operation button 50 displaying “H” are simultaneously enlarged.

Whichever the operation button 50 intended to be operated by the user is the operation button 50 displaying “G” or the operation button 50 displaying “H”, the control performed as described above causes the operation button 50 intended to be operated by the user to be enlarged.

### Modification 5

In Modification 4 of the exemplary embodiment described above, if the finger makes the series of motions of exiting and entering the operation detection areas 60 for the respective operation buttons 50, the operation buttons 50 are enlarged. However, if the operation buttons 50 are small in size, for example, the following case is considered. If the finger makes the series of motions of exiting and entering only one of the operation detection area 60 for the operation button 50, the user intends to operate a different one of the operation buttons 50 that is adjacent to the operation button 50.

Hence, in Modification 5 of this exemplary embodiment, if the coordinates of the detected finger fall inside the operation detection area 60 for one of the operation buttons 50 a set number of times or more within the time period set in advance, the controller 35 enlarges the operation buttons 50 including the operation button 50 on the display screen of the touch panel 40.

Specifically, if the coordinates of the detected finger fall inside the operation detection area 60 for one of the operation buttons 50 the set number of times or more within the time period set in advance, the controller 35 enlarges, on the display screen of the touch panel 40, the operation buttons 50 disposed close to the operation button 50.

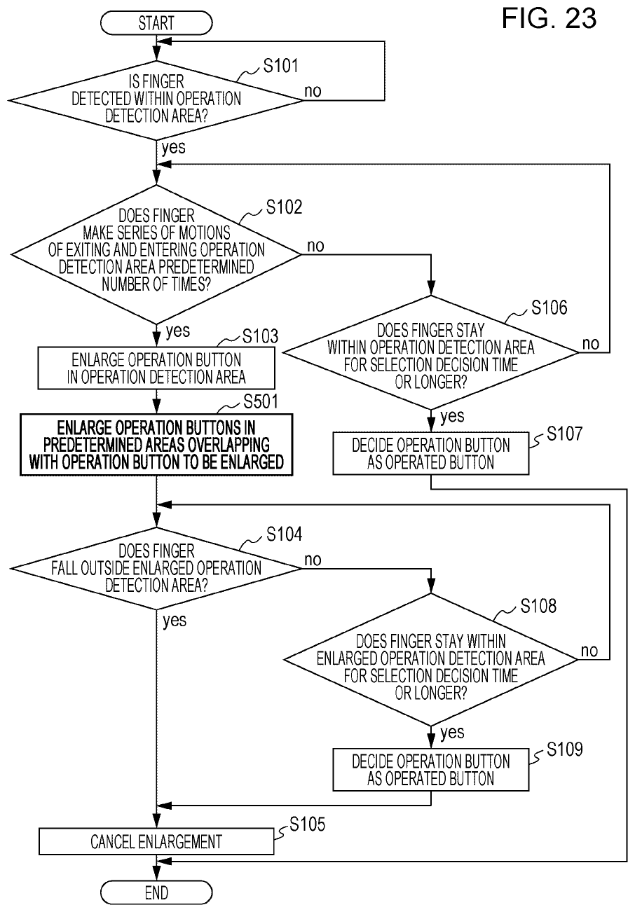

An operation for detecting a non-contact operation of the touch panel 40 of the image forming apparatus 10 in Modification 5 of this exemplary embodiment will then be described with reference to a flowchart in FIG. 23.

The flowchart in FIG. 23 has the same steps as those in the flowchart illustrated in FIG. 7 except that step S501 is added between step S103 and step S104. The description of steps other than step S501 in the flowchart in FIG. 23 is thus omitted.

In Modification 5 of this exemplary embodiment, if it is determined in step S102 that the finger of the user has made the series of motions of exiting and entering the operation detection area 60 the predetermined number of times, the controller 35, in step S103, enlarges, on the touch panel 40, the operation button 50 corresponding to the operation detection area 60 which the finger makes the series of motions of exiting and entering the predetermined number of times.

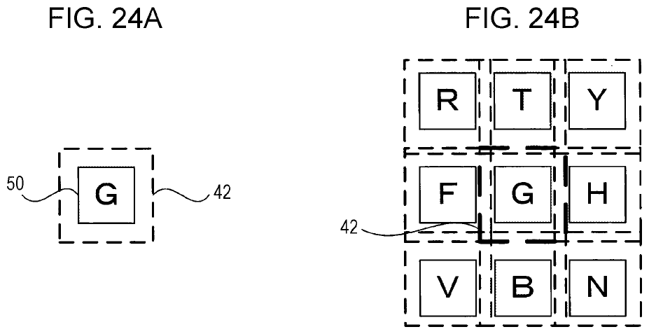

In Modification 5 of this exemplary embodiment, as illustrated in FIG. 24A, a predetermined area 42 is set around each of the operation buttons 50. The controller 35 determines that the operation buttons 50 having overlapping the predetermined areas 42 are close to each other. Specifically, the controller 35 determines that the operation buttons 50 (R, T. Y. F. H. V. B, and N) in the predetermined areas 42 overlapping with an operation buttons 50 (G) are the operation buttons 50 disposed close to the operation button 50 (G) as illustrated in FIG. 24B.

If an operation button 50 is enlarged in step S103, the controller 35, in step S501, enlarges the operation buttons 50 in the predetermined areas 42 overlapping with the operation button 50 to be enlarged.

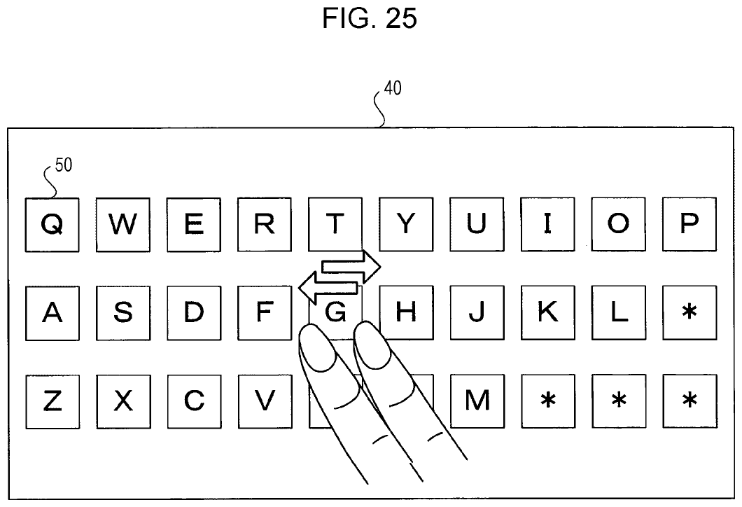

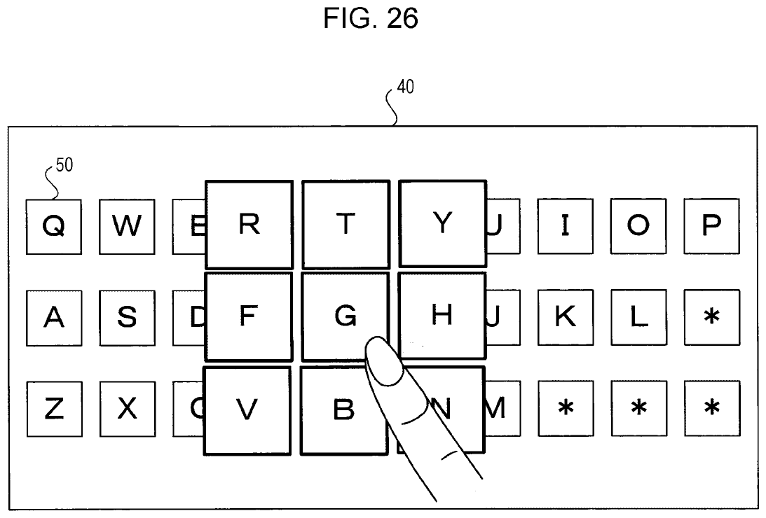

For example, a case where the finger of the user has made the series of motions of exiting and entering the operation detection area 60 for the operation button 50 displaying “G” the predetermined number of times as illustrated in FIG. 25 will be described. In Modification 5 of this exemplary embodiment, as illustrated in FIG. 26, if an operation as illustrated in FIG. 25 is performed, not only the operation button 50 displaying “G” but also the eight operation buttons 50 displaying “R”, “T”, “Y”, “F”, “H”, “V”, “B”, and “N” and disposed close to the operation button 50 displaying “G” are enlarged.

Even if an operation button intended to be operated by the user is actually the operation button 50 displaying “F”, the control as described above causes the operation button intended to be operated by the user to be enlarged.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The system in this exemplary embodiment includes both of a system composed of multiple apparatuses and a system composed of an apparatus.

### MODIFICATIONS

For the aforementioned exemplary embodiment, the case where a non-contact operation is received with the touch panel of the image forming apparatus such as the multi-function printer has been described, but the present disclosure is not limited to this. The present disclosure is also likewise applicable to a case where a non-contact operation is received with the touch panel of an information processing system including various information processing apparatuses such as a ticket-vending machine, a terminal apparatus as an automatic teller machine (ATM), and a ticket-issuing device.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))
An information processing system includes:
a processor configured to:
in receiving a non-contact operation of one of multiple operators displayed on a display screen on which an operation surface is laminated, the multiple operators having respective operation detection areas each set for a corresponding one of the multiple operators that are displayed on the display screen and set for detecting an operation of the operator, the receiving being performed in response to detection of an instructing object approaching the display screen, the non-contact operation being performed in a state where the instructing object is not in contact with the operation surface,
enlarge, on the display screen, one of the multiple operators displayed on the display screen, the operator being enlarged in response to a coordinate of the detected instructing object falling inside one of the operation detection areas for the operator a set number of times or more within a time period set in advance.
(((2)))
In the information processing system according to (((1))),
the processor is configured to:
   set predetermined area larger than the respective operation detection areas, and enlarge one of the operators on the display screen in response to the coordinate of the detected instructing object falling inside one of the operation detection areas set for the operator within a corresponding one of the predetermined areas the set number of times or more within a time period set in advance.
(((3)))
In the information processing system according to (((1))) or (((2))),
the processor is configured to: in response to a user performing an operation determined as not requiring the operator to be enlarged, increase a count for enlarging an operator.
(((4)))
In the information processing system according to (((3))), the processor is configured to: in response to an operation for deciding selection of one of the operators, increase the count for enlarging an operator without enlarging the operator subjected to the operation for deciding selection.
(((5)))
In the information processing system according to (((3))), the processor is configured to: in response to an operation for deciding selection of one of the operators not being performed after the operator is enlarged, increase the count for enlarging an operator.
(((6)))
In the information processing system according to (((5))), the processor is configured to: in response to an area of the operator taking on a value lower than or equal to a value set in advance or a distance to an operator adjacent to the operator taking on a value lower than or equal to a value set in advance even though the operation for deciding the selection of the operator is not performed after the operator is enlarged, not increase the count for enlarging an operator.
(((7)))
In the information processing system according to any one of (((1))) to (((6))), the processor is configured to: in response to the coordinate of the detected instructing object falling inside one of the operation detection areas for a corresponding one of the operators the set number of times or more within the time period set in advance, enlarge, on the display screen, more than one operator including the operator among the multiple operators.
(((8)))
In the information processing system according to (((7))), the processor is configured to: in response to the coordinate of the detected instructing object falling inside more than one operation detection area of the operation detection areas for corresponding more than one operator of the multiple operators the set number of times or more within the time period set in advance, enlarge the more than one operator on the display screen.
(((9)))
In the information processing system according to (((7))), the processor is configured to: in response to the coordinate of the detected instructing object falling inside one of the operation detection areas for a corresponding one of the operators the set number of times or more within the time period set in advance, enlarge, on the display screen, more than one operator disposed close to the operator among the multiple operators.
(((10)))
A program causes a computer to execute a process including:
receiving a non-contact operation of one of multiple operators displayed on a display screen on which an operation surface is laminated, the multiple operators having respective operation detection areas each set for a corresponding one of the multiple operators that are displayed on the display screen and set for detecting an operation of the operator, the receiving being performed in response to detection of an instructing object approaching the display screen, the non-contact operation being performed in a state where the instructing object is not in contact with the operation surface; and
enlarging, on the display screen, one of the multiple operators displayed on the display screen, the operator being enlarged in response to a coordinate of the detected instructing object falling inside one of the operation detection areas for the operator a set number of times or more within a time period set in advance.

What is claimed is:

1. An information processing system comprising:
a processor configured to:
in receiving a non-contact operation of one of a plurality of operators displayed on a display screen on which an operation surface is laminated, the plurality of operators having respective operation detection areas each set for a corresponding one of the plurality of operators that are displayed on the display screen and set for detecting an operation of the operator, the receiving being performed in response to detection of an instructing object approaching the display screen, the non-contact operation being performed in a state where the instructing object is not in contact with the operation surface,
enlarge, on the display screen, one of the plurality of operators displayed on the display screen, the operator being enlarged in response to a coordinate of the detected instructing object falling inside one of the operation detection areas for the operator a set number of times or more within a time period set in advance.

2. The information processing system according to claim 1,
wherein the processor is configured to:
set predetermined area larger than the respective operation detection areas, and enlarge one of the operators on the display screen in response to the coordinate of the detected instructing object falling inside one of the operation detection areas set for the operator within a corresponding one of the predetermined areas the set number of times or more within a time period set in advance.

3. The information processing system according to claim 1,
wherein the processor is configured to:
in response to a user performing an operation determined as not requiring the operator to be enlarged, increase a count for enlarging an operator.

4. The information processing system according to claim 3,
wherein the processor is configured to:
in response to an operation for deciding selection of one of the operators, increase the count for enlarging an operator without enlarging the operator subjected to the operation for deciding selection.

5. The information processing system according to claim 3,
wherein the processor is configured to:
in response to an operation for deciding selection of one of the operators not being performed after the operator is enlarged, increase the count for enlarging an operator.

6. The information processing system according to claim 5,
wherein the processor is configured to:
in response to an area of the operator taking on a value lower than or equal to a value set in advance or a distance to an operator adjacent to the operator taking on a value lower than or equal to a value set in advance even though the operation for deciding the selection of the operator is not performed after the operator is enlarged, not increase the count for enlarging an operator.

7. The information processing system according to claim 1,
wherein the processor is configured to:
in response to the coordinate of the detected instructing object falling inside one of the operation detection areas for a corresponding one of the operators the set number of times or more within the time period set in advance, enlarge, on the display screen, more than one operator including the operator among the plurality of operators.

8. The information processing system according to claim 7,
wherein the processor is configured to:
in response to the coordinate of the detected instructing object falling inside more than one operation detection area of the operation detection areas for corresponding more than one operator of the plurality of operators the set number of times or more within the time period set in advance, enlarge the more than one operator on the display screen.

9. The information processing system according to claim 7,
wherein the processor is configured to:
in response to the coordinate of the detected instructing object falling inside one of the operation detection areas for a corresponding one of the operators the set number of times or more within the time period set in advance, enlarge, on the display screen, more than one operator disposed close to the operator among the plurality of operators.

10. A non-transitory computer readable medium storing a program causing a computer to execute a process comprising:
receiving a non-contact operation of one of a plurality of operators displayed on a display screen on which an operation surface is laminated, the plurality of operators having respective operation detection areas each set for a corresponding one of the plurality of operators that are displayed on the display screen and set for detecting an operation of the operator, the receiving being performed in response to detection of an instructing object approaching the display screen, the non-contact operation being performed in a state where the instructing object is not in contact with the operation surface; and
enlarging, on the display screen, one of the plurality of operators displayed on the display screen, the operator being enlarged in response to a coordinate of the detected instructing object falling inside one of the operation detection areas for the operator a set number of times or more within a time period set in advance.

11. An information processing method comprising:
receiving a non-contact operation of one of a plurality of operators displayed on a display screen on which an operation surface is laminated, the plurality of operators having respective operation detection areas each set for a corresponding one of the plurality of operators that are displayed on the display screen and set for detecting an operation of the operator, the receiving being performed in response to detection of an instructing object approaching the display screen, the non-contact operation being performed in a state where the instructing object is not in contact with the operation surface; and
enlarging, on the display screen, one of the plurality of operators displayed on the display screen, the operator being enlarged in response to a coordinate of the detected instructing object falling inside one of the operation detection areas for the operator a set number of times or more within a time period set in advance.
